(19) United States
(12) Patent Application Publication
(10) Pub. No.: US 2026/0236420 A1
(43) Pub. Date: Aug. 13, 2026

(54) SEMICONDUCTOR DEVICE AND METHOD FOR CONTROLLING THE SEMICONDUCTOR DEVICE

(71) Applicant: RENESAS ELECTRONICS CORPORATION, Tokyo (JP)

(72) Inventors: Shoei AIDA, Tokyo (JP); Tomohiro KUROSHIMA, Tokyo (JP); Yusuke YASUDA, Tokyo (JP)

(21) Appl. No.: 19/424,881

(22) Filed: Dec. 18, 2025

(30) Foreign Application Priority Data
Feb. 13, 2025 (JP) 2025-021770

(51) Int. Cl. G06F 13/40; G06F 13/362

(52) U.S. Cl. CPC G06F 13/4022; G06F 13/362

(57) ABSTRACT

A semiconductor device and a method of controlling the semiconductor device to capable suppressing access delay from the bus master are provided. The semiconductor device includes a bus master, a bus slave, a bus that connects the bus master and the bus slave via multiple paths, a bus monitor that detects access requests from the bus master to the bus slave, and a selection unit that selects the path through which the bus transfers the access request based on the latency occurring in the multiple paths when an access request is detected.

### CROSS-REFERENCE TO RELATED APPLICATIONS

The disclosure of Japanese Patent Application No. 2025-021770 filed on February 13, 2025, including the specification, drawings and abstract is incorporated herein by reference in its entirety.

### BACKGROUND

The present invention relates to a semiconductor device and a method for controlling a semiconductor device and can be suitably used for a semiconductor device and a method for controlling a semiconductor device that includes a bus connecting a bus master and a bus slave, for example.

There are disclosed techniques listed below.

[Patent Document 1] Japanese Unexamined Patent Application Publication No. 2016-173798

For example, Patent Document 1 is known as a related technique. Patent Document 1 discloses a semiconductor device in which a plurality of bus masters and a plurality of bus slaves are connected via a bus. Furthermore, Patent Document 1 discloses a semiconductor device in which a bus control device arbitrates access from a bus master to a bus slave based on busy information of the bus slave.

### SUMMARY

However, in related technologies such as Patent Document 1, there may be cases where the delay in access from the bus master cannot be suppressed.

Other objects and novel features will become apparent from the description of this specification and the accompanying drawings.

According to one embodiment, the semiconductor device includes a bus that connects the bus master and the bus slave via multiple paths. When an access request from the bus master to the bus slave is detected, the semiconductor device selects a path for the bus to transfer the access request based on the latency occurring in multiple paths.

According to the embodiment, the delay in access from the bus master can be suppressed.

### BRIEF DESCRIPTION OF THE DRAWINGS

FIG. 1 is a configuration diagram showing the configuration of a semiconductor device according to an examined example.

FIG. 2 is a diagram for explaining the issues of the semiconductor device according to the examined example.

FIG. 3 is a configuration diagram showing the general configuration of a semiconductor device according to the embodiment.

FIG. 4 is a configuration diagram showing a configuration example of a semiconductor device according to the first embodiment.

FIG. 5 is a diagram showing the address space of a semiconductor device according to the first embodiment.

FIG. 6 is a configuration diagram showing a configuration example of a bus monitor management module according to the first embodiment.

FIG. 7 is a diagram showing an example of path selection for a semiconductor device according to the first embodiment.

FIG. 8 is a flowchart showing an example of operation of a semiconductor device according to the first embodiment.

FIG. 9 is a configuration diagram for explaining an example of operation of a semiconductor device according to the first embodiment.

FIG. 10 is a diagram for explaining a data example of a semiconductor device according to the first embodiment.

FIG. 11 is a diagram for explaining an example of operation of a semiconductor device according to the first embodiment.

FIG. 12 is a diagram for explaining an example of operation of a semiconductor device according to the first embodiment.

FIG. 13 is a diagram for explaining an example of operation of a semiconductor device according to the first embodiment.

FIG. 14 is a configuration diagram showing a configuration example of a bus monitor management module according to the second embodiment.

FIG. 15 is a flowchart showing an example of operation of a semiconductor device according to the second embodiment.

FIG. 16 is a timing chart showing an example of operation of a related semiconductor device.

FIG. 17 is a timing chart showing an example of operation of a semiconductor device according to the second embodiment.

FIG. 18 is a configuration diagram showing a configuration example of a semiconductor device according to the third embodiment.

FIG. 19 is a flowchart showing an example of operation of a semiconductor device according to the third embodiment.

FIG. 20 is a diagram showing an example of path selection for a semiconductor device according to the third embodiment.

### DETAILED DESCRIPTION

Below, the embodiments will be described with reference to the drawings. For clarity of explanation, the following description and drawings are appropriately omitted and simplified. In the drawings, the same elements are denoted by the same reference numerals, and a repetitive description thereof is omitted as necessary.

### Examination of Related Technologies

In recent years, the functions of vehicles and IoT (Internet of Things) devices have become more advanced. They are controlled by semiconductor devices such as MCUs (Micro Controller Units) and SoCs (Systems on Chip). With the advancement of functions, many bus masters are now being installed in these MCUs and SoCs. For example, the installation of multiple CPU (Central Processing Unit) cores and the multi-channelization of DMA (Direct Memory Access) are progressing. On the other hand, many bus slaves such as peripheral functions and memory are also installed, and a configuration in which these bus masters and bus slaves are connected by a bus and multiple buses are installed for each application is generally adopted. Bus monitors are also installed in some SoCs and MCUs as a function to monitor the congestion level of these buses and notify the software.

As the number of bus masters increases, the opportunities for access conflicts increase, and the delay in access due to bus conflicts becomes a problem, leading to a decrease in the overall performance of the SoC and MCU systems. Therefore, in the embodiment, attention is paid to the fact that the bus is composed of multiple buses and the bus monitor function, and means for performing more efficient bus access are provided.

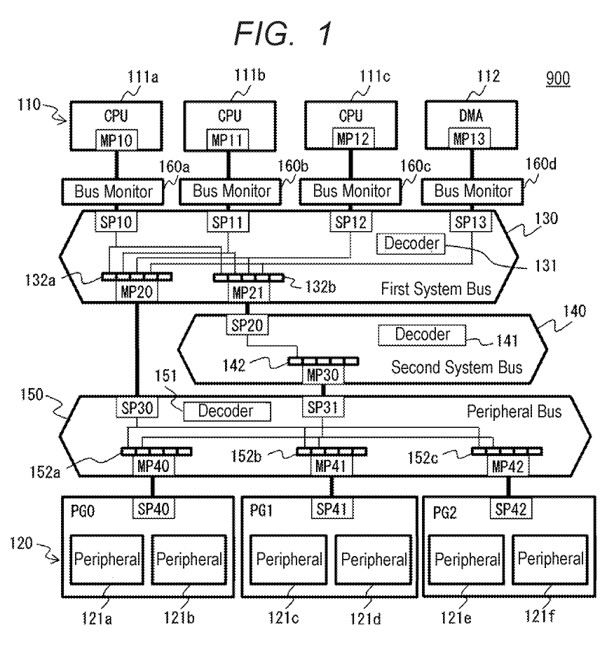

FIG. 1 shows the configuration of a semiconductor device 900 according to an examined example. In the example of FIG. 1, the semiconductor device 900 includes a plurality of bus masters 110, a plurality of bus slaves 120, a first system bus 130, a second system bus 140, a peripheral bus 150, and a plurality of bus monitors 160. The number of each component in FIG. 1 is an example and is not limited.

The plurality of bus masters 110 include, for example, CPUs 111a, 111b, 111c, and a DMA 112. The bus master 110 is not limited to CPUs and DMA and may be a circuit with other functions. The CPUs 111a, 111b, 111c, and the DMA 112 each include master ports MP10 to MP13 for connecting to the first system bus 130.

The plurality of bus slaves 120 include, for example, peripherals 121a to 121f. The bus slave 120 is not limited to peripherals and may be a circuit with other functions. The peripherals 121a to 121f are peripheral circuits with any peripheral functions. For example, the peripherals 121a to 121f are grouped into any number of peripheral groups. By accessing a peripheral group, any peripheral within the peripheral group can be accessed. For example, peripheral group PG0 includes peripherals 121a and 121b. Peripheral group PG1 includes peripherals 121c and 121d. Peripheral group PG2 includes peripherals 121e and 121f. The peripheral groups PG0 to PG2 each include slave ports SP40 to SP42 for connecting to the peripheral bus 150. Each peripheral may not be grouped into a peripheral group.

The bus monitor 160 is connected between the bus master 110 and the first system bus 130 and monitors signals input and output between the bus master 110 and the first system bus 130.

The bus monitor 160 monitors access requests from the bus master 110 and responses from the bus slave 120 to the access requests. The bus monitor 160 can notify the monitoring results to software, etc. For example, bus monitors 160a to 160d monitor signals between CPUs 111a, 111b, 111c, DMA 112, and the first system bus 130, respectively.

The first system bus 130 is a bus that connects the plurality of bus masters 110 with the second system bus 140 and the peripheral bus 150. The first system bus 130 includes slave ports SPs 10 to 13 for connecting to CPUs 111a, 111b, 111c, and DMA 112, respectively. The first system bus 130 includes master ports MP20 and MP21 for connecting to the peripheral bus 150 and the second system bus 140, respectively. The first system bus 130 may connect the bus master 110 and the peripheral group (or peripheral).

For example, the first system bus 130 includes a decoder 131, and arbiters 132a and 132b. The decoder 131 decodes the access destination address of the access request from the bus master 110 and outputs the access request to the arbiter 132a or arbiter 132b according to the decoded address. The arbiter 132a arbitrates access requests output from the master port SP20 to the peripheral bus 150. The arbiter 132b arbitrates access requests output from the master port MP21 to the second system bus 140.

The second system bus 140 is a bus that connects the first system bus 130 and the peripheral bus 150. The second system bus 140 includes a slave port SP20 for connecting to the first system bus 130. The second system bus 140 includes a master port MP30 for connecting to the peripheral bus 150. The second system bus 140 may connect multiple first system buses 130 and multiple peripheral buses 150. The second system bus 140 may connect the bus master 110 and the peripheral group (or peripheral).

For example, the second system bus 140, like the first system bus 130, includes a decoder 141 and an arbiter 142. The decoder 141 decodes the access destination address of the access request from the first system bus 130 and outputs the access request to the arbiter 142 according to the decoded address. The arbiter 142 arbitrates access requests output from the master port MP30 to the peripheral bus 150.

The peripheral bus 150 is a bus that connects the first system bus 130 and the second system bus 140 with multiple bus slaves 120. The peripheral bus 150 includes slave ports SP30 to SP31 for connecting to the first system bus 130 and the second system bus 140, respectively. The peripheral bus 150 includes master ports MP40 to MP42 for connecting to peripheral groups PG0 to PG2, respectively. Additionally, the peripheral bus 150 may connect between the bus master 110 and the peripheral group (or peripheral).

For example, the peripheral bus 150, like the first system bus 130, includes a decoder 151 and arbiters 152a to 152c. Decoder 151 decodes the destination address of access requests from the first system bus 130 and the second system bus 140. The decoder 151 outputs the access request to one of the arbiters 152a to 152c according to the decoded address. The arbiter 152a arbitrates access requests output from master port MP40 to peripheral group PG0 (including peripherals 121a, 121b). The arbiter 152b arbitrates access requests output from master port MP41 to peripheral group PG1 (including peripherals 121c, 121d). The arbiter 152c arbitrates access requests output from master port MP42 to peripheral group PG2 (including peripherals 121e, 121f).

In the example of FIG. 1, when accessing the bus slave 120 from the bus master 110, it can pass through the first system bus 130, the second system bus 140, and the peripheral bus 150. For example, all bus masters 110 may use only one path between the first system bus 130 and the peripheral bus 150 according to priority. In this case, if access from the bus master 110 is concentrated on arbiter 132a of the first system bus 130, delays in accessing the bus slave 120 occur.

The inventors examined the issues when applying the technology of Patent Document 1 to the configuration of FIG. 1. In Patent Document 1, the bus control device acquires access information indicating the bus slave being accessed by each of the multiple bus masters based on the address signals output by the multiple bus masters. The bus control device acquires busy information indicating whether each bus slave is in a busy state. The bus control device arbitrates access from each bus master to a non-busy bus slave based on the acquired access information and busy information, according to the priority set for each bus master.

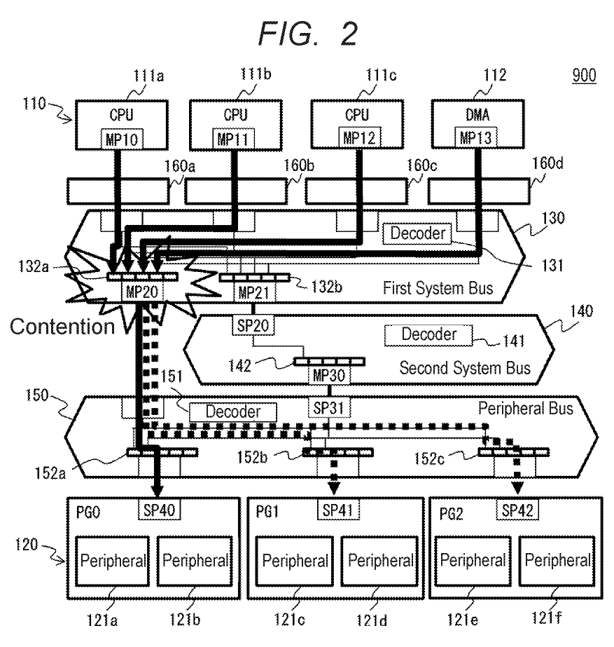

FIG. 2 shows the issues when applying the technology of Patent Document 1 to the configuration of FIG. 1. Here, considers the situation where CPU 111a is accessing peripheral group PG0 while CPU111b is accessing peripheral group PG1. Both CPUs 111a and 111b access each peripheral group via the path from the first system bus 130 to the peripheral bus 150. Therefore, even though peripheral group PG1 is not busy, access cannot be made due to contention occurring at arbiter 132a of the first system bus 130. The same applies when CPU 111c or DMA 112 accesses peripheral groups PG1 or PG2. In other words, if the access order is determined by only looking at the busy state of the bus slave as in the technology of Patent Document 1, situations like FIG. 2 cannot be resolved, and delays due to contention cannot be suppressed.

### Overview of the Embodiment

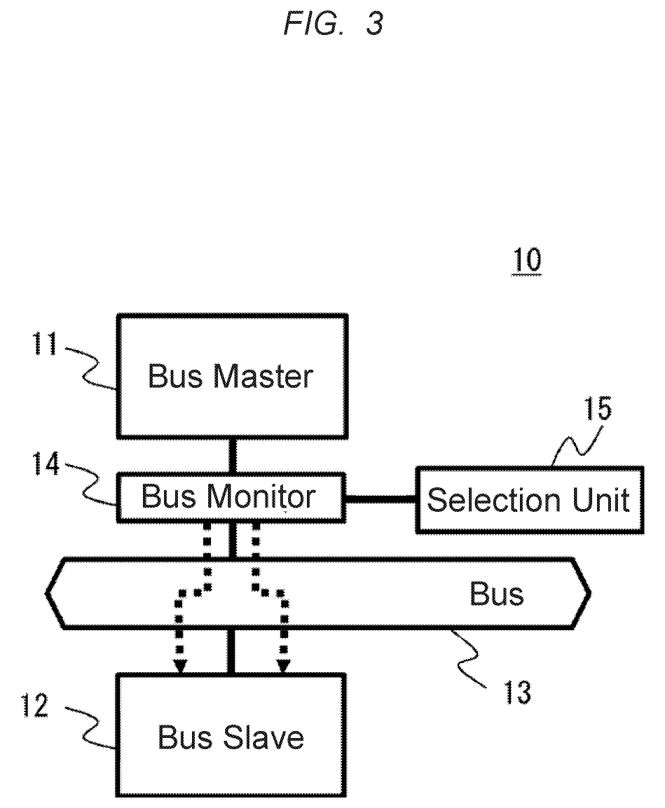

FIG. 3 shows an overview configuration of a semiconductor device 10 according to the embodiment. In the example of FIG. 3, semiconductor device 10 includes a bus master 11, a bus slave 12, a bus 13, a bus monitor 14, and a selection unit 15. The semiconductor device 10 may include multiple bus masters 11, multiple bus slaves 12, and multiple buses 13.

The bus 13 connects between the bus master 11 and the bus slave 12 via multiple paths. The bus 13 transfers access requests from bus master 11 to bus slave 12 via any of the paths. The bus 13 may include a system bus or a peripheral bus.

The bus monitor 14 is connected between the bus master 11 and the bus 13. The bus monitor 14 detects access requests from the bus master 11 to the bus slave 12. The selection unit 15 selects the path through which bus 13 transfers the access request based on the latency caused by the access request in multiple paths when the access request is detected by the bus monitor 14.

For example, the semiconductor device 10 may include a calculation unit that calculates the latency caused by the access request in multiple paths each time an access request is detected. The calculation unit may calculate the latency in multiple paths based on the predetermined necessary processing time required for access processing by the access request in the path selected by the selection unit 15. The selection unit 15 may select a path based on the latency in the calculated multiple paths when the next access request is detected after the calculation unit calculates the latency.

In the embodiment, when an access request from the bus master to the bus slave is detected, the path through which the bus transfers the access request is selected based on the latency caused by the access request in multiple paths via the bus. This allows the path through which the bus transfers the access request to be appropriately switched, thereby suppressing delays in access from the bus master.

### First Embodiment

Next, the first embodiment will be described.

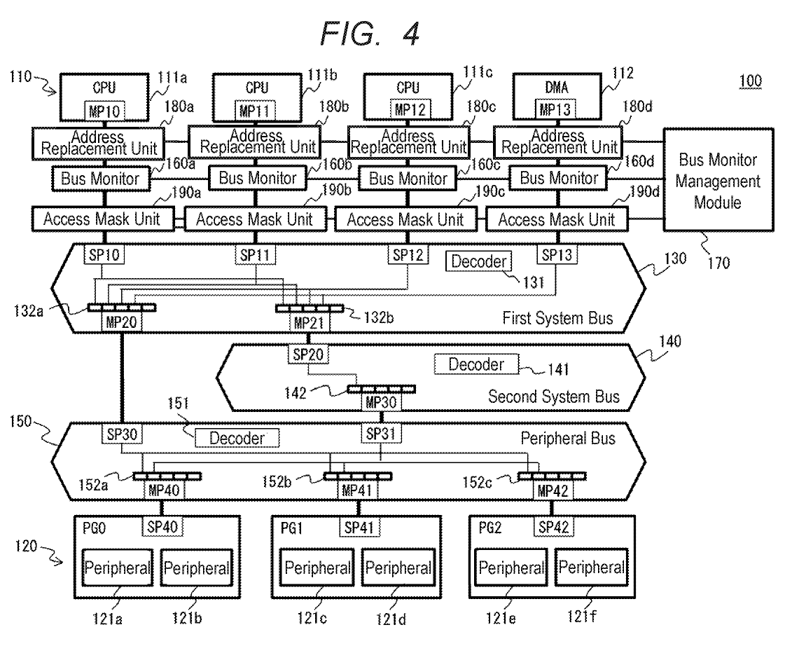

FIG. 4 shows a configuration example of a semiconductor device 100 according to the present embodiment. FIG. 4 is an example in which the present embodiment is applied to the configuration of FIG. 1. The semiconductor device 100 may be configured by one or any number of semiconductor devices (e.g., semiconductor chips). The semiconductor device 100 may be, for example, an MCU or SoC.

In the example of FIG. 4, the semiconductor device 100 includes multiple bus masters 110, multiple bus slaves 120, a first system bus 130, a second system bus 140, a peripheral bus 150, and multiple bus monitors 160. These are similar to FIG. 1. The first system bus 130, the second system bus 140, and the peripheral bus 150 are examples of buses, and other buses may be used as long as multiple paths can be configured between multiple bus masters 110 and multiple bus slaves 120. The semiconductor device 100 further includes a bus monitor management module 170, multiple address replacement units 180, and multiple access mask units 190.

The bus monitor 160 is connected between the bus master 110 and the first system bus 130, similar to FIG. 1. The bus monitor 160 monitors signals input and output between the bus master 110 and the first system bus 130. When the bus monitor 160 detects an access request from the bus master 110, it notifies the bus monitor management module 170 of the destination address of the access request. For example, bus monitors 160a to 160d detect access requests from CPUs 111a, 111b, 111c, and DMA 112, respectively.

The bus monitor management module 170 controls access from the bus master 110 according to the monitoring results of the bus monitor 160. The bus monitor management module 170 is connected to multiple bus monitors 160, multiple address replacement units 180, and multiple access mask units 190.

The bus monitor management module 170 receives the destination address of the access request from the bus monitor 160 and selects the access path to execute the access request. The bus monitor management module 170 selects the path with the shortest latency due to access from multiple paths via the first system bus 130, the second system bus 140, and the peripheral bus 150. The bus monitor management module 170 updates (calculates) the latency due to access as needed and selects the access path based on the updated latency. The bus monitor management module 170 notifies the corresponding address replacement unit 180 of the selected access path. Additionally, the bus monitor management module 170 notifies the corresponding access mask unit 190 of the masking and unmasking of the access request. This controls the timing at which the access request from the bus monitor 160 is output to the first system bus 130.

The access mask unit 190 is connected between the bus monitor 160 and the first system bus 130. The access mask unit 190 receives notifications of masking and unmasking of access requests from the bus monitor management module 170 and performs masking and unmasking of access requests from bus master 110. Access mask units 190a to 190d perform masking and unmasking of access requests from CPUs 111a, 111b, 111c, and DMA 112, respectively.

The access mask unit 190 is a stop unit that stops the output of the access request to the first system bus 130 from the time the access request from the bus master 110 is detected until the destination address of the access request is replaced. The access mask unit 190 stops the output of the access request to the first system bus 130 by masking the access request from the bus master 110. For example, masking an access request means applying the inverted signal (mask pattern) of the access request to stop the signal output of the access request. Additionally, the access mask unit 190 initiates the output of the access request to the first system bus 130 by unmasking the access request from the bus master 110. It should be noted that stopping and starting the output of access requests can be achieved by methods other than masking.

The address replacement unit 180 is connected between the bus master 110 and the bus monitor 160. The address replacement unit 180 receives information on the selected access path from the bus monitor management module 170 and replaces the destination address of the access request from the bus master 110 according to the access path information. The address replacement units 180a to 180d replace (convert) the destination addresses of access requests from CPUs 111a, 111b, 111c, and DMA 112 with the addresses of the selected alternate paths. For example, the address replacement unit 180 replaces the destination address of an access request with an address for a bypass route when a bypass route is selected. In this embodiment, a mirror address, which is a mirrored version of the address for the normal route, is used as the address for the bypass route.

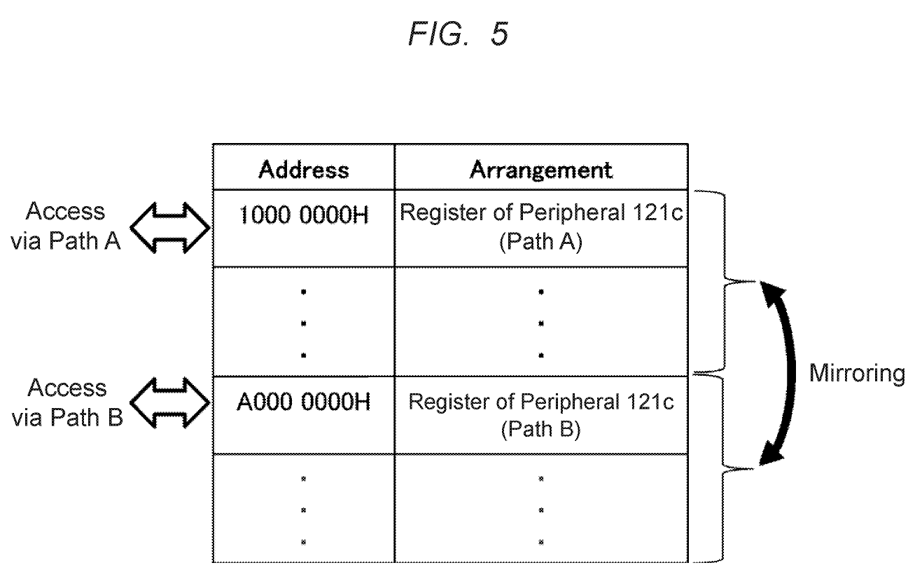

FIG. 5 shows an example of mirroring the destination address of an access request in the address space according to this embodiment. As shown in FIG. 5, the destination addresses of the two paths are assigned to separate address spaces and mirrored. The address used for access via the peripheral bus 150 (path A) (10000000H) and the address used for access via the second system bus 140 (path B) (A0000000H) are defined separately. For example, path A is the normal route, and path B is the bypass route. The two addresses actually point to the same register (peripheral 121c). For example, if the address replacement unit 180 specifies the address (10000000H) as the destination address of an access request, the register of peripheral 121c can be accessed via the peripheral bus 150 (path A). If the address replacement unit 180 specifies the address (A0000000H) as the destination address of an access request, the register of peripheral 121c can be accessed via the second system bus 140 (path B). The mirrored addresses in the address space, as shown in FIG. 5, are set in decoder 131 of the first system bus 130, decoder 141 of the second system bus, and decoder 151 of the peripheral bus 150. For example, the relationship between the normal route address and the output destination port, and the relationship between the bypass route address and the output destination port, are pre-set in decoder 131, decoder 141, and decoder 151.

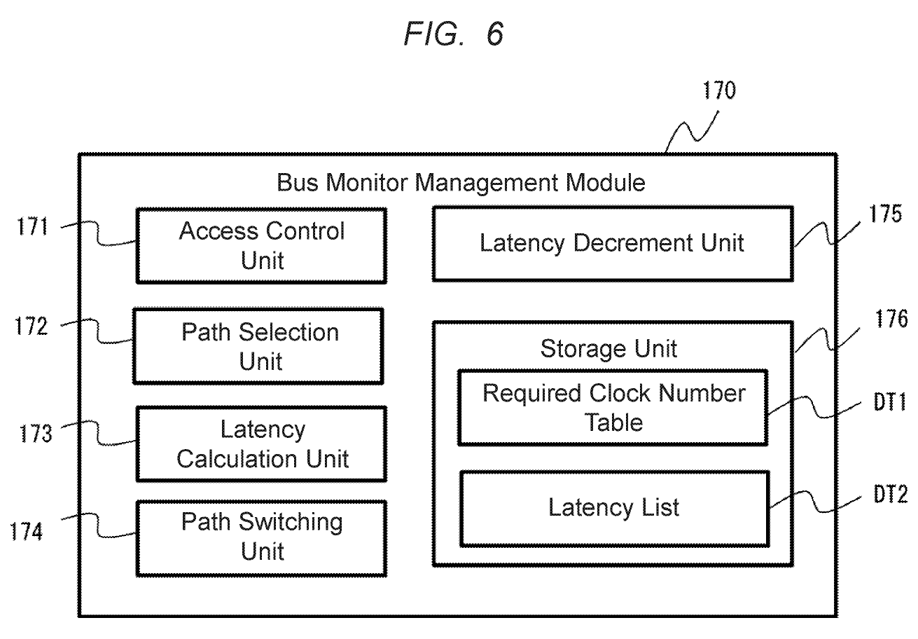

FIG. 6 shows an example configuration of the bus monitor management module 170 according to this embodiment. It should be noted that as long as the operation according to this embodiment is possible, configurations other than that shown in FIG. 6 may also be used.

In the example of FIG. 6, the bus monitor management module 170 includes an access control unit 171, a path selection unit 172, a latency calculation unit 173, a path switching unit 174, a latency decrement unit 175, and a storage unit 176.

The access control unit 171 controls the masking of access requests from the bus master 110. By masking the access request, it prevents the access request from being output to the first system bus 130 until the path selection and address replacement (path switching) of the access request are completed. The access control unit 171 controls the masking of access requests by notifying the relevant access mask unit 190 of the masking and unmasking of access requests.

The path selection unit 172 selects an access path based on latency when an access request is detected by the bus monitor 160. The path selection unit 172 refers to the latency list DT2 in storage unit 176 and selects an access path based on the destination address of the access request and the latency calculation results of the normal and bypass routes. The path selection unit 172 selects the path with the shorter latency between the normal route and the bypass route.

The latency calculation unit 173 calculates the latency for access requests on each path. The latency calculation unit 173 calculates and updates the latency for the next access request based on the path selected by the path selection unit 172.

The storage unit 176 stores the required clock number table DT1 and the latency list DT2. The required clock number table DT1 is a table that holds the number of clocks required for access as a fixed value for all combinations of paths. The latency list DT2 shows the calculation results of the latency required from the occurrence of an access request to the completion of access for all combinations of access paths at the current time. The latency calculation unit 173 calculates the latency of each path based on the required clock number in the required clock number table DT1 and updates the latency in the latency list DT2. The calculation results of latency in the latency list DT2 take into account the access status of all bus masters 110 and are updated in real-time. The latency decrement unit 175 decrements the latency of each path in the latency list DT2 as time progresses.

The path switching unit 174 instructs the address replacement unit 180 to switch to the path selected by the path selection unit 172. The path switching unit 174 notifies the relevant address replacement unit 180 of the selected path and switches the path of the detected access request.

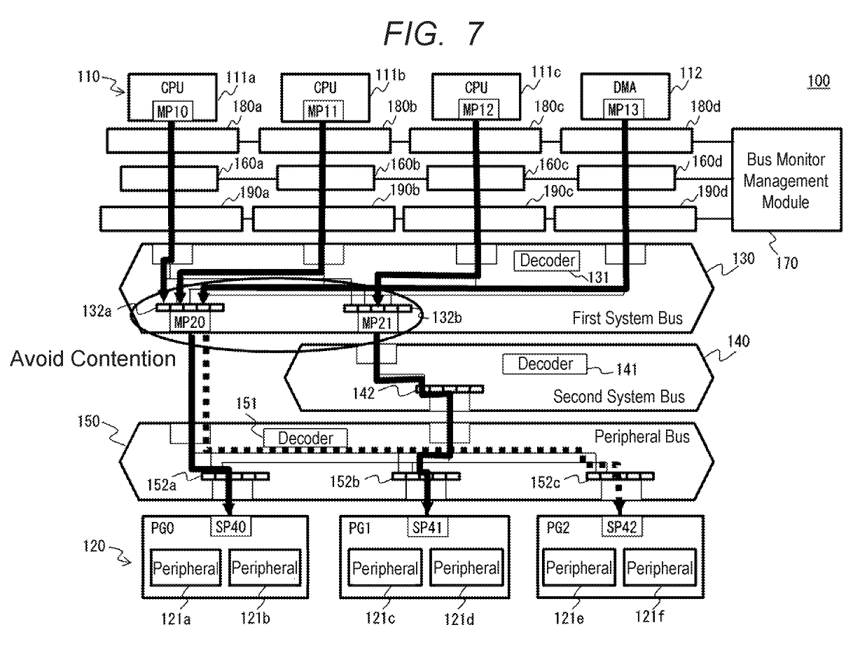

FIG. 7 shows an example of path selection in the semiconductor device 100 according to this embodiment. In this embodiment, the related technical issues are resolved without changing the general bus configuration. Specifically, access requests generated from each bus master 110 are detected by their respective bus monitors 160, and the access path is selected based on the latency calculated by the bus monitor management module 170. Furthermore, the address replacement unit 180 changes the access path to a bypass route. When accessing from the bus master 110 to the bus slave 120, even if the arbiter 132a is congested, access to bus slave 120 is made via the bypass route of the second system bus 140. This avoids access delays due to contention in the arbiter 132a. In the example of FIG. 7, a bypass route is selected to avoid contention of the access request from CPU 111c in the arbiter 132a.

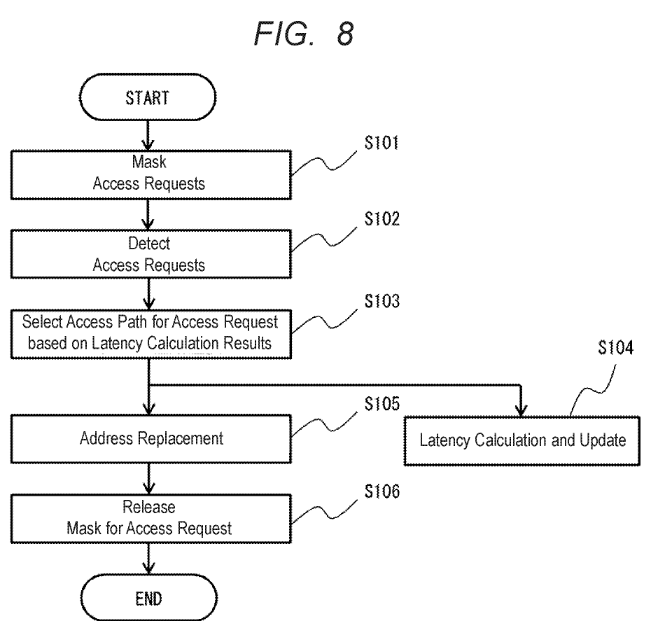

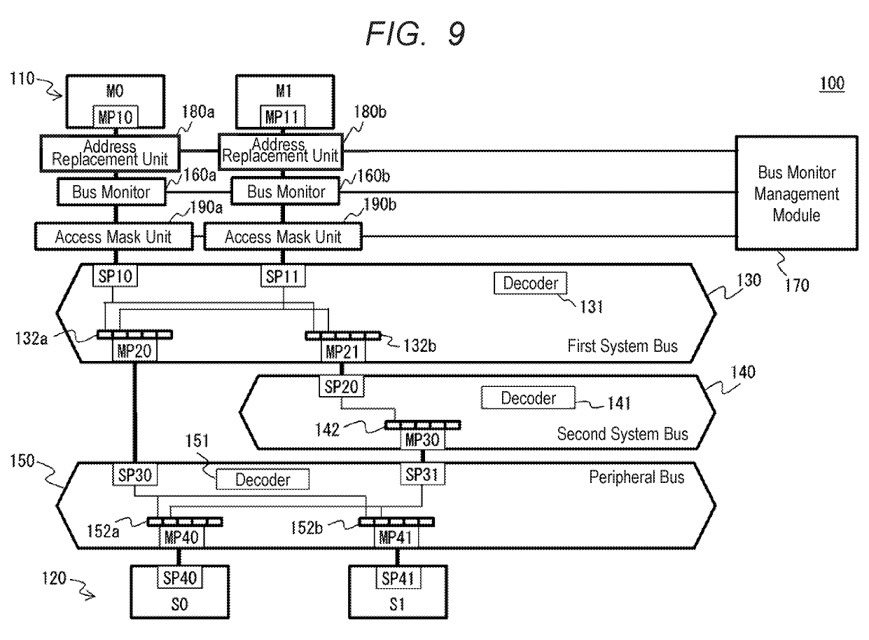

FIG. 8 shows an example of the operation of the semiconductor device 100 according to this embodiment. Here, for simplification of explanation, an example configuration of the semiconductor device 100 in FIG. 9 is used to explain the operation example in FIG. 8. In the example of FIG. 9, the semiconductor device 100 includes two bus masters M0 and M1 as the bus master 110, and two bus slaves S0 and S1 as the bus slave 120.

As shown in FIG. 8, the access mask unit 190 masks the access requests from the bus master 110 in advance (S101). The access control unit 171 instructs the access mask units 190a and 190b to mask the access requests. The access mask units 190a and 190b mask the access requests from bus masters M0 and M1 according to the instructions from the access control unit 171.

Subsequently, the bus monitor 160 detects access requests from the bus master 110 (S102). The bus monitors 160a and 160b monitor access requests from bus masters M0 and M1, and notify the bus monitor management module 170 of the destination address of the access request when an access request is detected.

Subsequently, the path selection unit 172 selects an access path for the access request based on the latency calculation results (S103). The path selection unit 172 selects an access path based on the destination address of the access request and the latency calculation results of the normal and bypass routes when the destination address of the access request is notified by the bus monitor 160. The path selection unit 172 refers to the latency in the latency list DT2, which is the latency calculation result. The path selection unit 172 selects the path with the shorter latency between the normal route and the bypass route. If the latency of the normal route and the bypass route is the same, either the normal route or the bypass route may be selected.

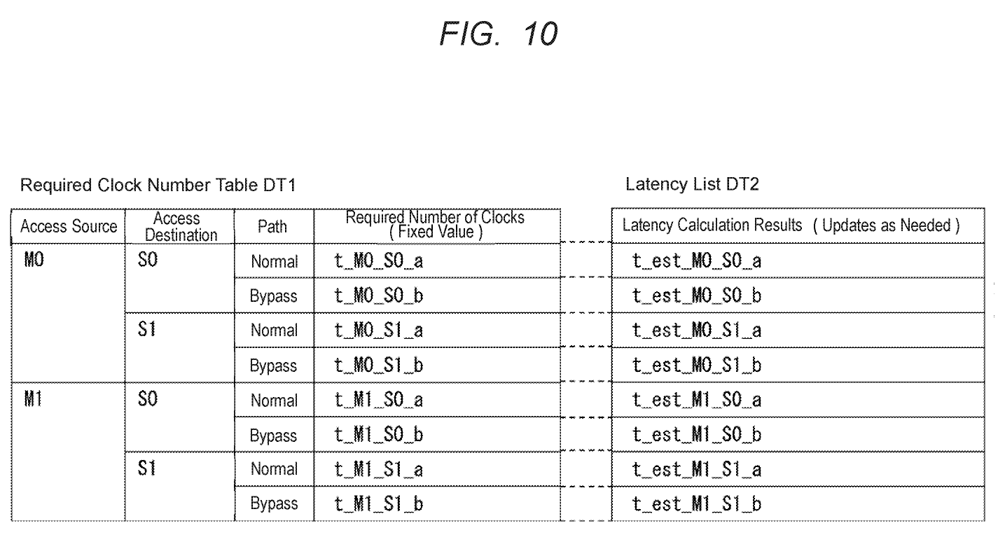

FIG. 10 shows examples of the required clock number table DT1 and the latency list DT2 in the configuration of FIG. 9. For example, the required clock number table DT1 defines the number of clocks required for each path (normal route and bypass route) in the combination of the access source (bus masters M0 and M1) and the access destination (bus slaves S0 and S1). The required number of clocks is the number of clocks necessary for processing by the bus and bus slave of each path for access. The required number of clocks is a predefined fixed value, but it may be changed as necessary. For example, the bus monitor 160 may monitor the response (access completion) from the bus slave and adjust the required number of clocks according to the response time. Not limited to the required number of clocks, the necessary processing time for access may also be used. For example, the necessary processing time may be based on the number of clocks and clock frequency in the bus and bus slave.

The latency list DT2 stores the latency calculation results, similar to the required number of clocks in the required clock number table DT1. For example, the latency calculation results are stored for each route (normal route and detour route) in the combination of the access source (bus masters M0 and M1) and the access destination (bus slaves S0 and S1).

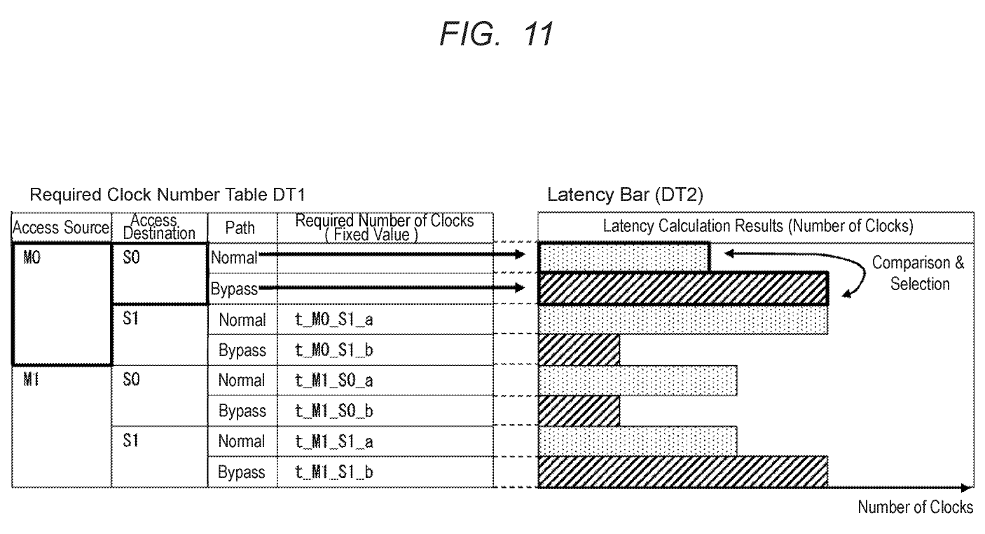

FIG. 11 shows each latency of the latency list DT2 in FIG. 10 with a latency bar for explanation. FIG. 11 shows the latency comparison and access route selection when an access request from bus master M0 to bus slave S0 occurs. For example, bus monitor 160a detects an access request from bus master M0 to bus slave S0 and notifies the bus monitor management module 170. The route selection unit 172 receives from bus monitor 160a that an access request from bus master M0 to bus slave S0 has been detected. The route selection unit 172 refers to the latency list DT2 and compares the latency of the normal route and the detour route from bus master M0 to bus slave S0. In this example, route selection unit 172 selects the normal route with shorter latency.

Following S103, latency calculation and update (S104) and address replacement (S105) are performed. S104 and S105 are performed independently and in parallel. That is, the latency calculation unit 173 calculates and updates the latency based on the selected route (S104). The latency calculation unit 173 updates the latency calculation results for the next access when an access route is selected.

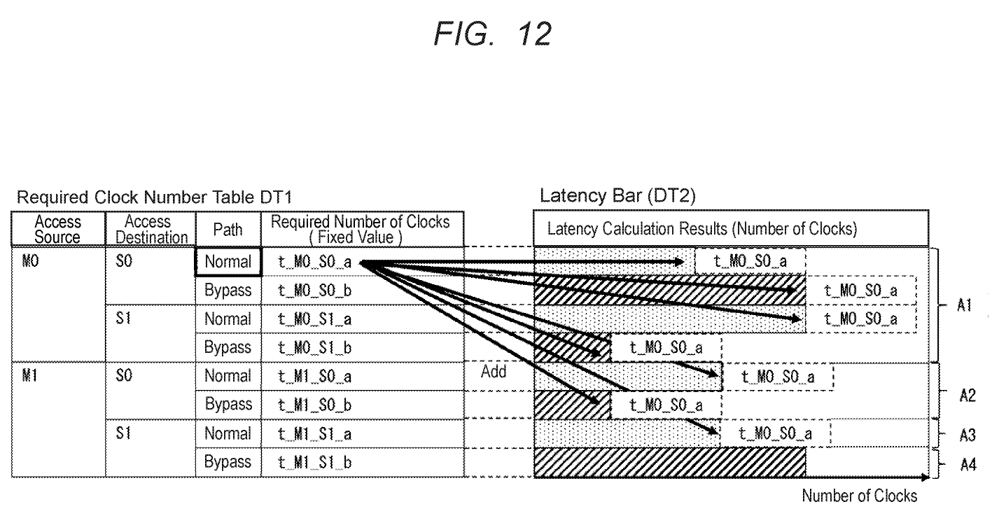

FIG. 12 shows an example of updating the latency calculation results. The latency calculation unit 173 updates the latency calculation results of routes affected by the access of the selected route. For example, if the normal route is selected for an access request from the bus master M0 to the bus slave S0, it causes delays for all access routes except the detour route from the bus master M1 to the bus slave S1. As in code A1, for the normal and detour routes from the bus master M0 to the bus slave S0, and the normal and detour routes from the bus master M0 to the bus slave S1, the next access is delayed until the access from the bus master M0 is completed. As in code A2, for the normal and detour routes from the bus master M1 to the bus slave S0, the next access is delayed until the access to the bus slave S0 is completed. As in code A3, for the normal route from the bus master M1 to the bus slave S1, the next access is delayed until the access on the normal route is completed. As in code A4, the detour route from the bus master M1 to the bus slave S1 is not affected by the access on the normal route. The latency calculation unit 173 updates the latency calculation results for all access routes except the detour route from the bus master M1 to the bus slave S1. Specifically, it adds the required number of clocks (t_M0_S0_a) for the normal route from the bus master M0 to the bus slave S0.

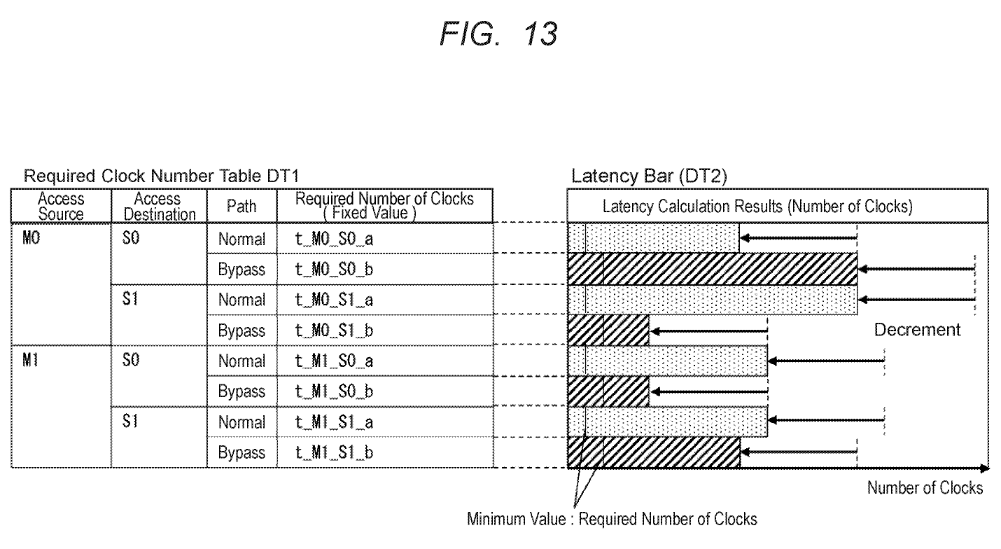

Additionally, the latency decrement unit 175 decrements the latency calculation results according to the passage of time. The decrement process is executed independently of the process in FIG. 8. FIG. 13 shows an example of decrementing the latency calculation results. The latency decrement unit 175 decrements the latency calculation results for all access routes in the latency list DT2 over time. For example, it decrements by one clock for each clock. The latency decrement unit 175 repeats the decrement until the minimum latency value for each route is reached. The minimum latency value for each route matches the required number of clocks for that route. By setting the minimum latency value for each route as the required number of clocks for that route, it is possible to select a route based on the latency of each route even if there is an initial access before latency calculation.

Returning to FIG. 8, following S103, the address replacement unit 180 replaces the address of the access request based on the selected route (S105). The route switching unit 174 notifies the address replacement unit 180 of the selected route. For example, if the normal route is selected for an access request from bus master M0 to bus slave S0, the route switching unit 174 notifies the address replacement unit 180a that the normal route has been selected. The address replacement unit 180 outputs the input access request without replacing the access destination address with a mirror address if the normal route is selected. Additionally, if the detour route is selected for an access request from the bus master M0 to the bus slave S0, the route switching unit 174 notifies the address replacement unit 180a that the detour route has been selected. The address replacement unit 180 replaces the access destination address with a mirror address and outputs the access request after address replacement if the detour route is selected.

Subsequently, the access mask unit 190 releases the mask for the access request (S106). The access control unit 171 notifies the relevant access mask unit 190 to release the mask for the access request to execute access on the selected route. For example, if the normal route or detour route is selected for an access request from the bus master M0 to the bus slave S0, the access control unit 171 notifies the access mask unit 190a to release the mask for the access request.

As a result, if the normal route is selected, the access request output from the bus master M0 passes through the access mask unit 190a and is output to the first system bus 130. On the first system bus 130, the access request is output to bus slave S0 via the normal route from arbiter 132a according to the access destination address of the access request. Additionally, if the detour route is selected, the access request output from bus master M0 and address-replaced by address replacement unit 180a passes through the access mask unit 190a and is output to the first system bus 130. On the first system bus 130, the access request is output to the bus slave S0 via the detour route from the arbiter 132b according to the access destination address (mirror address) of the access request.

In this embodiment, based on the access request from the bus master to the bus slave, the latency of each route caused by the access is calculated, and the route for executing the access is selected based on the calculated latency of each route. For example, if the latency of the detour route is shorter than the latency of the normal route, the detour route is selected. This suppresses competition by the bus arbiter and prevents access delays.

Additionally, the address replacement unit can switch the access route by replacing the access destination address of the access request according to the selected route. For example, mirror the access destination address for the normal route and detour route, and replace the access destination address of the access request with a mirror address. This allows the bus master to switch access to the detour route without changing the access destination address.

### Second Embodiment

Next, the second embodiment will be described. For example, in the first embodiment, if the access destination addresses of multiple access requests from multiple bus masters are the same, selecting different routes may change the access order in the bus slave. Therefore, in this embodiment, if the access destination addresses of multiple access requests are the same, the same route is selected. The configuration of the semiconductor device 100 is the same as in FIG. 4 of the first embodiment.

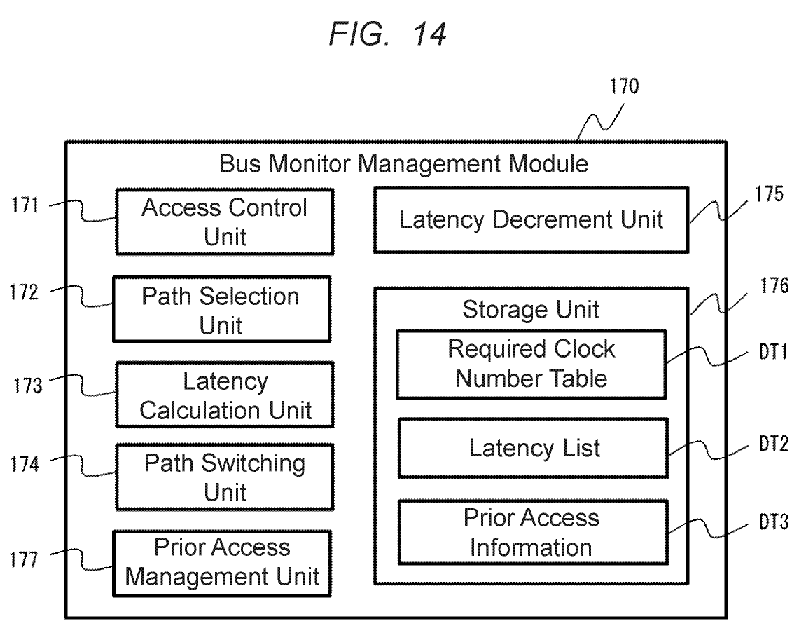

FIG. 14 shows a configuration example of the bus monitor management module 170 according to this embodiment. In the example of FIG. 14, the storage unit 176 stores the prior access information DT3. Prior access information DT3 is information indicating prior access to bus slave 120 and information indicating access in progress (during access). Prior access information DT3 includes the access source, access destination, route, etc., of the prior access in progress for each bus slave 120. For example, access in progress (during access) refers to the state from outputting an access request to the bus slave 120 until a response (access completion) is returned from bus slave 120.

Additionally, the bus monitor management module 170 includes prior access management unit 177 in addition to the configuration of FIG. 6. Prior access management unit 177 manages the prior access information DT3. For example, the prior access management unit 177 manages the execution state of each access by receiving the detection results of access requests and responses from bus monitor 160. Prior access management unit 177 registers the information of the access in progress (including access source, access destination, and route) in the prior access information DT3 when the route of the access request is selected and access is started. Prior access management unit 177 deletes the information of the relevant access from the prior access information DT3 when the access in progress registered in the prior access information DT3 is completed.

The route selection unit 172 refers to the prior access information DT3 to check for the presence of prior access to the same access destination as the detected access request when an access request is detected. If there is prior access to the same access destination, the route selection unit 172 selects the same route as prior access as the route for the access request.

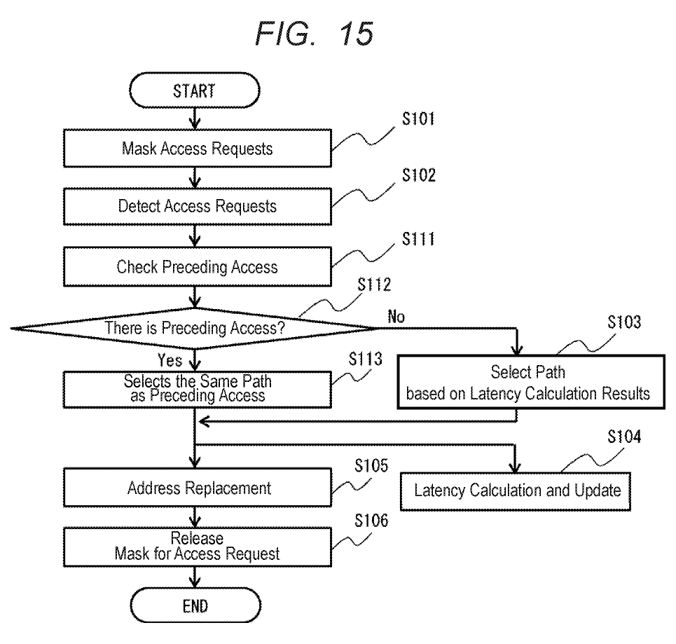

FIG. 15 shows an example of the operation of the semiconductor device 100 according to this embodiment. S101 to S106 are the same as in FIG. 8.

In the example of FIG. 15, similar to FIG. 8, the access mask unit 190 preemptively masks access requests from the bus master 110 (S101). Subsequently, the bus monitor 160 detects access requests from the bus master 110 (S102).

Next, the path selection unit 172 checks the preceding access information DT3 (S111) and determines whether there is preceding access to the same destination as the detected access request (S112). If there is a preceding access to the same destination, the path selection unit 172 selects the same path as the preceding access for the access request (S113). If there is no preceding access to the same destination, the path selection unit 172 selects a path for the access request based on the latency calculation results, similar to FIG. 8 (S103).

Then, similar to FIG. 8, latency is calculated and updated based on the selected path (S104). In parallel with S104, the address of the access request is replaced based on the selected path (S105), and the mask for the access request is released (S106).

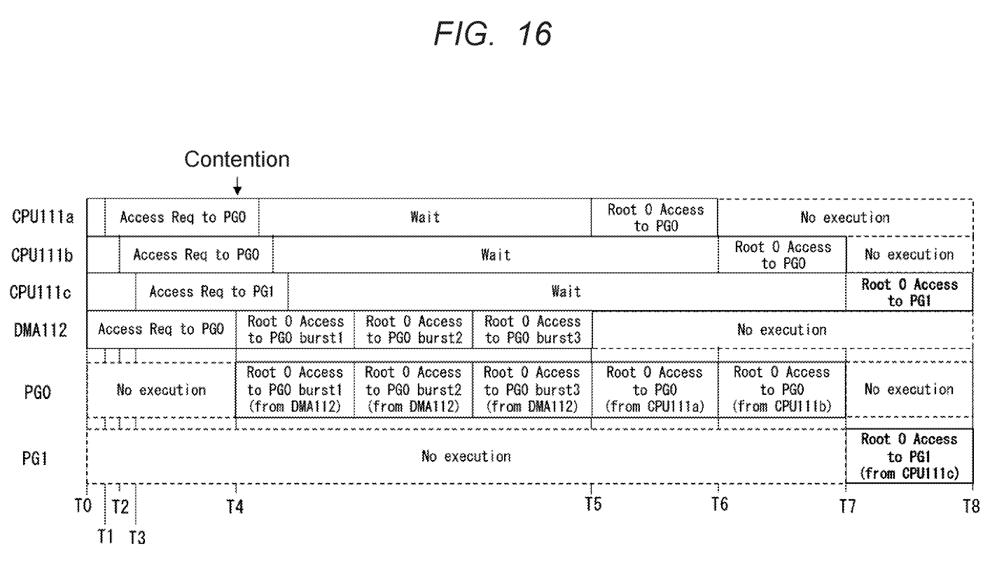

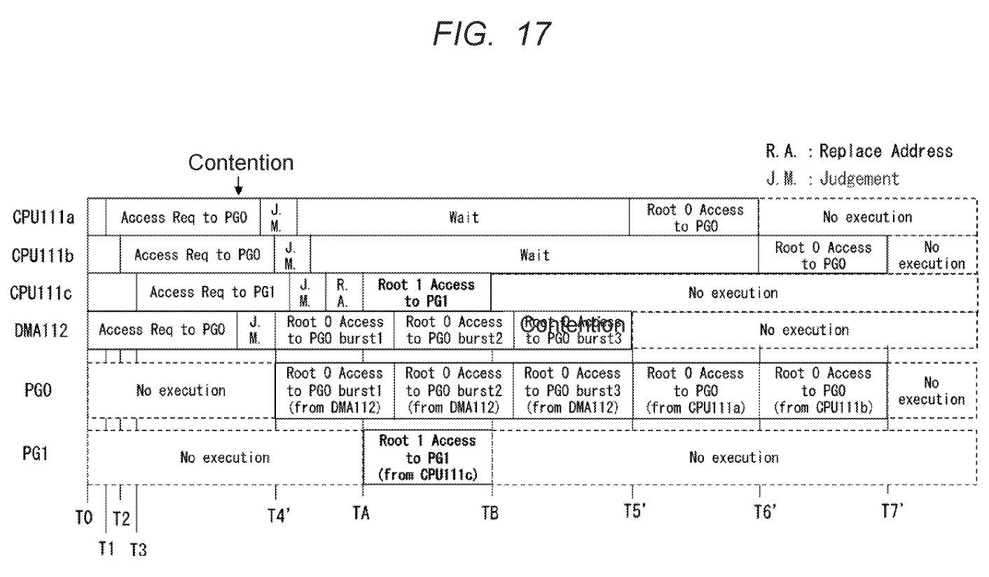

Using FIGS. 16 and 17, the effects of the present embodiment (including the first embodiment) are explained. FIG. 16 shows a timing chart of operations in related technology before applying the present embodiment. FIG. 17 shows a timing chart of operations in the present embodiment.

In FIGS. 16 and 17, at T0, an access request to peripheral group PG0 is output from the DMA 112. At T1, an access request to peripheral group PG0 is output from CPU111a. At T2, an access request to peripheral group PG0 is output from the CPU 111b. At T3, an access request to peripheral group PG1 is output from the CPU 111c. Therefore, at T4, four access requests compete.

As shown in FIG. 16, in related technology, access from the DMA 112 to peripheral group PG0 is executed from T4 to T5 via the normal path (path 0). Access from the CPU 111a to peripheral group PG0 remains in a waiting state until the DMA 112's access is completed, and after the DMA 112's access is completed, it is executed from T5 to T6 via the normal path (path 0). Access from the CPU 111b to peripheral group PG0 remains in a waiting state until the DMA 112 and the CPU 111a's access is completed. Therefore, access from CPU 111b is executed from T6 to T7 via the normal path (path 0) after the CPU 111a's access is completed. Access from CPU 111c to peripheral group PG1 remains in a waiting state until the DMA 112, the CPU 111a, and CPU 111b's access is completed. Therefore, access from the CPU 111c is executed from T7 to T8 via the normal path (path 0) after the CPU 111b's access is completed. In related technology, access processing from CPU111c to peripheral group PG1 is executed via the normal path, causing it to wait until the DMA 112, the CPU 111a, and the CPU 111b's access processing is completed.

In contrast, as shown in FIG. 17, in the present embodiment, judgment for path selection (J.M.: Judgement) and address replacement (R.A.: Replace Address) are performed for each access request. Accesses from the DMA 112, CPU 111a, 111b are to the same peripheral group PG0. Therefore, access requests from the DMA 112, the CPU 111a, 111b are executed in the same order as in FIG. 16. That is, access from the DMA 112 to peripheral group PG0 is executed from T4' to T5' via the normal path (path 0). Access from CPU111a to peripheral group PG0 is executed from T5' to T6' via the normal path (path 0). Access from CPU111b to peripheral group PG0 is executed from T6' to T7' via the normal path (path 0). Additionally, the access request from CPU111c to peripheral group PG1 differs in destination from the access requests of the DMA 112, the CPUs 111a and 111b. Therefore, access from the CPU 111c is executed from TA to TB after T4' via the detour path (path 1). Thus, in the present embodiment, access from the CPU 111c, which was delayed due to competition in related technology, can be executed at an earlier stage.

As described above, in the present embodiment, if the destination addresses of multiple access requests are the same, the same path is selected. This prevents the order of multiple accesses from being swapped in the bus slave. Additionally, if the destination addresses of multiple access requests differ, similar to the first embodiment, paths are selected based on latency calculation results to suppress delays.

### Third Embodiment

Next, the third embodiment is explained. In the present embodiment, in addition to the first or second embodiment, an example of selecting a normal path in case of path failure is explained.

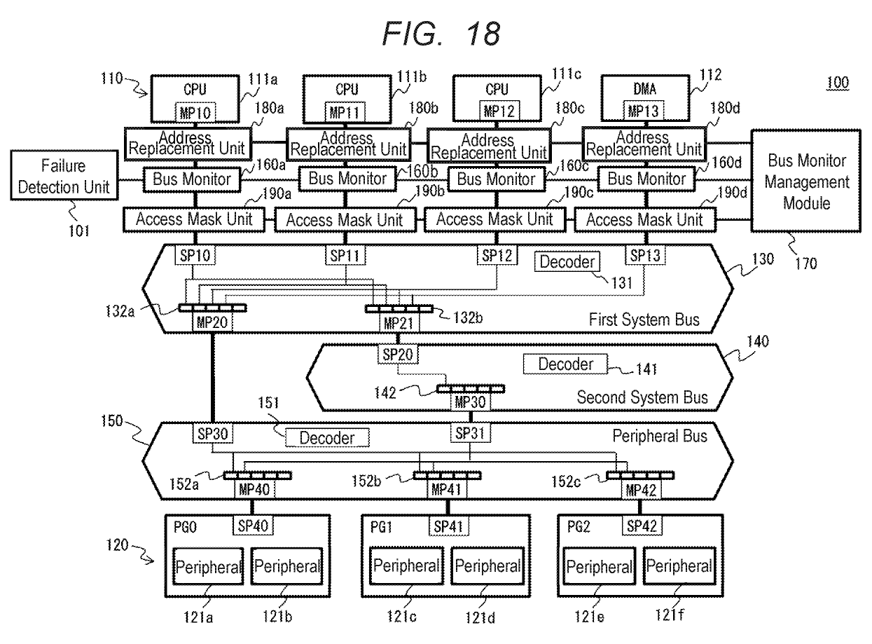

FIG. 18 shows a configuration example of a semiconductor device 100 according to the present embodiment. In the example of FIG. 18, semiconductor device 100 includes a failure detection unit 101 in addition to the configuration of FIG. 4.

The failure detection unit 101 detects failures in each path. Path failures include bus anomalies (no response), disconnections, shorts, etc. The method of path failure detection by the failure detection unit 101 is not limited. For example, the failure detection unit 101 may detect failures in each path based on the monitoring results of the bus monitor 160. For example, the bus monitor 160 may measure the latency of responses to access requests and detect path failures if there is no response for a certain period.

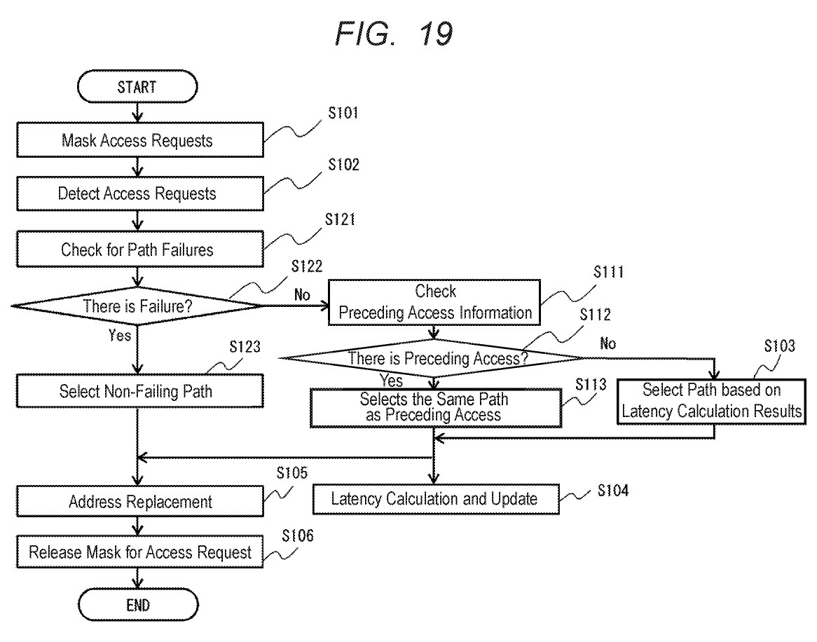

FIG. 19 shows an example of operation of semiconductor device 100 according to the present embodiment. S101 to S106 are similar to FIG. 8, and S111 to S113 are similar to FIG. 15.

In the example of FIG. 19, similar to FIG. 8, the access mask unit 190 preemptively masks access requests from the bus master 110 (S101). Subsequently, the bus monitor 160 detects access requests from the bus master 110 (S102).

Subsequently, the failure detection unit 101 checks for path failures (S121) and determines whether there is a failure in the path (S122). For example, the failure detection unit 101 checks for failures in multiple paths to the destination of the access request. If there is a failure in any path, the path selection unit 172 selects a non-failing path for the access request (S123). For example, if the normal path is failing, the detour path is selected, and if the detour path is failing, the normal path is selected. By setting a large value for the latency of failing paths in the latency list, non-failing paths can be selected based on latency during path selection.

If there is no failure in any path, similar to FIG. 15, preceding access information is checked (S111). Depending on the presence of preceding access (S112), the same path as the preceding access is selected (S113), or a path for the access request is selected based on latency calculation results (S103). Furthermore, latency is calculated and updated (S104). After S123, or in parallel with S104, similar to FIG. 8, the address of the access request is replaced (S105), and the mask for the access request is released (S106).

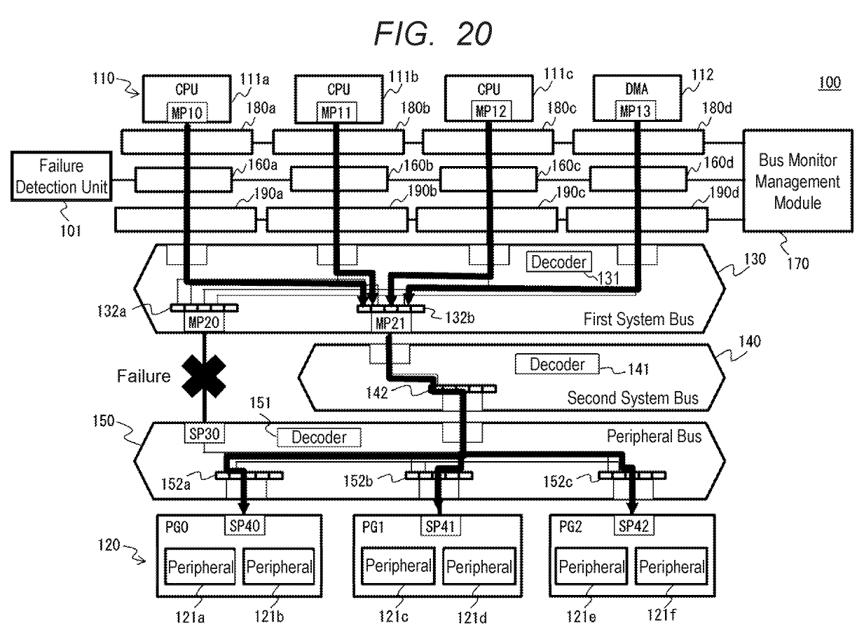

Thus, in the present embodiment, a normal path is selected in case of path failure. FIG. 20 shows an example of path selection when the path between the first system bus 130 and the peripheral bus 150 fails. If there is no response from the bus slave for a certain time in the path between the first system bus 130 and the peripheral bus 150, the destination addresses of access requests from all bus masters are replaced, and the detour path is selected.

Similar to embodiments 1 and 2, paths are selected based on latency calculation results. If a path failure is detected, a normally operating path is selected for all access requests, regardless of latency calculation results. In related technology, access paths are uniquely determined, so access becomes impossible in case of path failure, but in the present embodiment, continued operation is possible by selecting an alternative path through address mirroring even in case of path failure.

It should be noted that each element described and depicted in the drawings as functional blocks performing various processes can be configured in hardware as a CPU, memory, and other circuits. Additionally, in software, it can be realized by programs loaded into memory. Therefore, it is understood by those skilled in the art that these functional blocks can be realized in various forms by hardware alone, software alone, or a combination thereof, and the present invention is not limited to any of them.

The above programs can be stored and provided to a computer using various types of non-transitory computer readable media. Non-transitory computer readable media includes various types of tangible storage media. Examples of non-transitory computer-readable media include magnetic recording media (e.g., flexible disks, magnetic tapes, hard disk drives) and magneto-optical recording media (e.g., magneto-optical disks). Examples of non-transitory computer-readable media include CD-ROM (Read Only Memory), CD-R, CD-R/W, and semiconductor memory. Semiconductor memory includes masked ROM, PROM (Programmable ROM), EPROM (Erasable PROM), flash ROM, and RAM (Random Access Memory). The programs may also be supplied to the computer by various types of transitory computer-readable transitory computer readable media. Examples of transitory computer-readable media include electrical signals, optical signals, and electromagnetic waves. The transitory computer readable medium may provide the program to the computer via wired or wireless communication paths, such as electrical wires and optical fibers.

Although the invention made by the inventor has been specifically described based on the embodiment. However, the present invention is not limited to the embodiment already described, and it is needless to say that various modifications can be made without departing from the gist thereof.

What is claimed is:

1. A semiconductor device comprising:
a bus master;
a bus slave;
a bus for connecting the bus master and the bus slave via multiple paths;
a bus monitor for detecting access requests from the bus master to the bus slave; and
a selection unit for selecting a path for the bus to transfer the access request based on the latency occurring in the multiple paths when the access request is detected.

2. A semiconductor device according to claim 1 further comprising a calculation unit for calculating the latency in the plurality of paths based on a predetermined necessary processing time required for access processing by the access request in the selected path,
wherein the selection unit selects the path based on the calculated latency in the plurality of paths when the access request is next detected.

3. The semiconductor device according to claim 2 further comprising a storage unit for storing the latency of the calculated plurality of paths in a latency table,
wherein the calculation unit updates the latency in the plurality of paths stored in the latency table based on the required processing time.

4. The semiconductor device according to claim 3 further comprising a decrement unit for decrementing the latency in the plurality of paths stored in the latency table over time.

5. The semiconductor device according to claim 1,
wherein the selection unit selects the same path for the multiple access requests when multiple access requests are detected by the bus monitor and the destination of the multiple access requests is the same.

6. The semiconductor device according to claim 1 further comprising a fault detection unit for detecting faults in the plurality of paths,
wherein the selection unit selects a path in which no fault is detected when a fault is detected in any of the plurality of paths.

7. The semiconductor device according to claim 1 further comprising
an address replacement unit for replacing the destination address of the access request according to the selected path.

8. The semiconductor device according to claim 7,
wherein the destination address is an address mirrored for each route.

9. The semiconductor device according to claim 7 further comprising an access stop unit for stopping the output of the access request to the bus from the time the access request is detected until the access destination address of the access request is replaced.

10. The semiconductor device according to claim 9,
wherein the access stop unit halts the output of the access request to the bus by masking the access request.

11. A method for controlling a semiconductor device, comprising:
connecting a bus master and a bus slave via a bus through multiple paths;
detecting an access request from the bus master to the bus slave; and
selecting a path for the bus to transfer the access request based on the latency occurring in the multiple paths for the access request if the access request is detected.
